(19) United States
(12) Patent Application Publication
(10) Pub. No.: US 2025/0356255 A1
(43) Pub. Date: Nov. 20, 2025

(54) METHOD AND APPARATUS DISTRIBUTING CONTENT IN A SECURE MANNER

(71) Applicant: Being AI Limited, Auckland (NZ)

(72) Inventors: Nicolas Fourrier, Auckland (NZ); David McDonald, Auckland (NZ); Paul Shale, Auckland (NZ); Stephen Hogg, Auckland (NZ); Shanon Oden, Adams, MA (US)

(21) Appl. No.: 18/920,676

(22) Filed: Oct. 18, 2024

Related U.S. Application Data
(60) Provisional application No. 63/647,223, filed on May 14, 2024.

(51) Int. Cl. G06N 20/00

(52) U.S. Cl. CPC G06N 20/00

(57) ABSTRACT

Methods and systems for sharing user information with computing resources over a computer network. The method includes monitoring user interactions of a user device with at least one remote computing resource using a monitoring module installed on the user device. User preference information is determined based on the user interactions and stored in a preference database. A machine learning prediction module is trained based on the user preference information. In response to establishing a connection of the user device with at least one specific remote computing resource, the machine learning prediction module predicts information to share with the at least one specific remote computing resource based on the user preference information. The predicted information is then transmitted to the at least one specific computing resource.

### CROSS-REFERENCE TO RELATED APPLICATIONS

This application claims benefit to U.S. Provisional Application Ser. No. 63/647,223 filed on May 14, 2024, the entire disclosure of which is incorporated herein by reference.

### DESCRIPTION OF RELATED ART

The present disclosure relates to data management and sharing systems, and more particularly to an AI module, architecture, and protocol for personalized control and sharing of user information across digital platforms.

### BACKGROUND

Websites and online platforms have long utilized cookies and other tracking technologies to enhance the user experience, personalize content, and deliver targeted advertisements. These technologies allow websites to remember user preferences, login information, and browsing habits, thereby enabling a more tailored online experience. However, the proliferation of data collection and sharing practices has raised significant concerns about user privacy and data protection.

In recent years, privacy regulations such as the European General Data Protection Regulation (GDPR) and the California Consumer Privacy Act (CCPA) have been implemented to address these concerns and give users more control over their personal data. These regulations generally require websites to disclose their data collection and usage practices and obtain user consent before collecting certain types of data. Despite these efforts, many users find it challenging to navigate the complex landscape of cookie policies and privacy settings across the numerous websites they visit.

For example, prior to using various online web services, a user may be asked to consent to a highly dense and complex legal document that grants the service provider the permission to use data collected from the user in various ways. In many instances, merely using the service is deemed to be a waiver of user privacy rights. The technical and legal knowledge required to understand and manage cookie preferences and data policies often leads users to accept default settings or provide blanket consent without fully comprehending the implications. This behavior can result in unintended data sharing and an effective lack of ownership over personal information. Even as third-party cookies are phased out, the underlying issue of personal data control remains a significant challenge in the digital ecosystem.

As the online landscape continues to evolve, there is a growing need for more user-centric approaches to data management and privacy protection. Users increasingly seek ways to maintain control over their personal information while still benefiting from personalized online experiences. This balance between privacy and personalization presents a complex challenge for both users and online platforms.

### SUMMARY

This summary is provided to introduce a selection of concepts in a simplified form that are further described below in the Detailed Description. This summary is not intended to identify key features or essential features of the claimed subject matter, nor is it intended to define the scope of the claimed subject matter.

According to disclosed implementations, a method for sharing user information with computing resources over a computer network is provided. The method includes monitoring, with a monitoring module, user interactions of the user device with at least one remote computing resource. The method also includes determining user preference information based on the user interactions and storing the user preference information in a preference database. The method further includes training a machine learning prediction module based on the user preference information. In response to establishing a connection of the user device with at least one specific remote computing resource, the method includes predicting, through inference of the machine learning prediction module, information to share with the at least one specific remote computing resource based on the user preference information. The method also includes transmitting the information to share to the at least one specific computing resource.

According to other disclosed implementations of the present disclosure, the method may include one or more of the following features. The information to share may be in the form of cookies. The information to share may comprise smart home information collected from a user smart home platform. The information to share may comprise user profile information. The method may further comprise conducting negotiations with multiple remote computing resources to select the at least one specific remote computing resource for receipt of the information to share. The method may further comprise the user receiving compensation in response to the transmitting step. The transmitting step may be accomplished using one or more interfaces compatible with the at least one specific remote computing resource.

According to another disclosed implementation of the present disclosure, a system for managing user data sharing across computing devices is provided. The system includes a monitoring module configured to monitor user interactions with at least one remote computing resource. The system also includes a preference database configured to store user preference information determined from the user interactions. The system further includes a machine learning prediction module trained on the user preference information, and configured to, in response to establishing a connection with at least one specific remote computing resource, predict information to share with the at least one specific remote computing resource based on the user preference information. A transmitting module is configured to transmit the predicted information to the at least one specific computing resource.

According to another disclosed implementation of the present disclosure, a non-transitory computer-readable medium storing instructions is provided. When executed by a processor, the instructions cause the processor to perform operations comprising monitoring user interactions of a user device with at least one remote computing resource. The operations also include determining user preference information based on the user interactions and storing the user preference information in a preference database. The operations further include training a machine learning prediction module based on the user preference information. In response to establishing a connection with at least one specific remote computing resource, the operations include predicting information to share with the at least one specific remote computing resource based on the user preference information. The operations also include transmitting the predicted information to the at least one specific computing resource.

According to other disclosed implementations of the present disclosure, the non-transitory computer-readable medium may include one or more of the following features. The information to share may be in the form of cookies. The information to share may include information stored on/by any and all other user devices and open third party devices of relevance to the user. For example, the information can include a user's your photos, phone calls, emails, texts, and/or smart home information collected from a user smart home platform. The operations may further comprise conducting negotiations with multiple remote computing resources to select the at least one specific remote computing resource for receipt of the information to share. The user may own the information to share, and the operations may further comprise facilitating the user receiving compensation in response to transmitting the predicted information. Transmitting the predicted information may be accomplished using one or more interfaces compatible with the at least one specific remote computing resource.

### BRIEF DESCRIPTION OF FIGURES

Examples of disclosed implementations are described with reference to the following drawing.

FIG. 1 is a block diagram of a computing architecture in accordance with disclosed implementations.

FIG. 2 is a flowchart of a method in accordance with disclosed implementations.

### DETAILED DESCRIPTION

The following description sets forth exemplary disclosed implementations. It should be recognized, however, that such description is not intended as a limitation on the scope of the present disclosure. Rather, the description also encompasses combinations and modifications to those exemplary disclosed implementations described herein.

Disclosed implementations address the limitations of conventional systems noted above. Further, disclosed implementations address issues that will arise in the “agentic” future where the user/person might be absent from the process and thus nobody is present to provide human consent. In disclosed implementations, the agents will leverage historical use and/or preset consent conditions to control dissemination of information. The AI agent likely will know more about the user than any third-party cookie would ever have gathered. Further, the user can control their own agent's knowledge and use of that knowledge. For example, an Agent owned by the user. may present a message such as, “your agent is about to share this information with Facebook”, and the user can be required to acquiesce prior to sharing of information. The agent will acquire the knowledge around what is ok to share with FB and what is not ok to share with FB better than the user themselves and can gather and present such information for approval by the user.

Disclosed implementations provide a method and system for managing and sharing user information across digital platforms using an artificial intelligence (AI) module. This AI module can be installed on a user device, and can include an AI model that is trained (and/or self-trains) on data representing user interactions with remote computing resources, such as websites and applications. The AI module determines user preference information based on these interactions. The user preference information is gathered and stored in a preference database and used to train a machine learning prediction module (the AI model). This prediction module is thus configured to, in an inference operation, generate and/or identify data that the user is likely to want to share with specific remote computing resources, enhancing the user's control over their personal information.

In some implementations, upon establishing a connection with a specific remote computing resource, the AI module predicts the information to share based on the user preference information and transmits this information to the specific computing resource. The AI module can report the information it has gathered and its predictions with the user, allowing the user to manually overwrite or temporarily override the model. Also, the user can input new desired behaviors that have no data history (for example, I would normally eat a pizza but I have just started a diet today so I would like you to get me a salad (which I have never ordered before). The information to share may take various forms, including but not limited to, cookies, smart home information, user profile information, user generated content and/or configuration information.

The AI module may conduct negotiations with multiple remote computing resources to select a specific computing resource for receipt of the information to share and/or conditions of use of the information to share. This negotiation process may be automated and may involve the use of sophisticated algorithms designed to optimize data sharing based on user preferences and privacy settings.

The user may be considered as the owner of the information to share and can receive compensation in response to the transmission of this information. This feature provides users with an opportunity to monetize their personal data while maintaining control over their privacy. The AI module can include a transmission module that transmits the information using one or more interfaces compatible with the specific remote computing resource, ensuring seamless integration and compatibility across various digital platforms.

The AI module provides a balance between personalized and convenient user experiences and stringent data protection, offering a versatile tool for managing online interactions and data sharing. This balance may be achieved by giving users control over their personal data and how it is shared across various platforms and entities, while also ensuring compliance with privacy regulations. The AI module may be used across a wide range of applications, including but not limited to browsers, apps, and Internet of Things (IoT) devices. The present disclosure also encompasses a non-transitory computer-readable medium storing instructions that, when executed by a processor, cause the processor to perform operations consistent with the methods described herein.

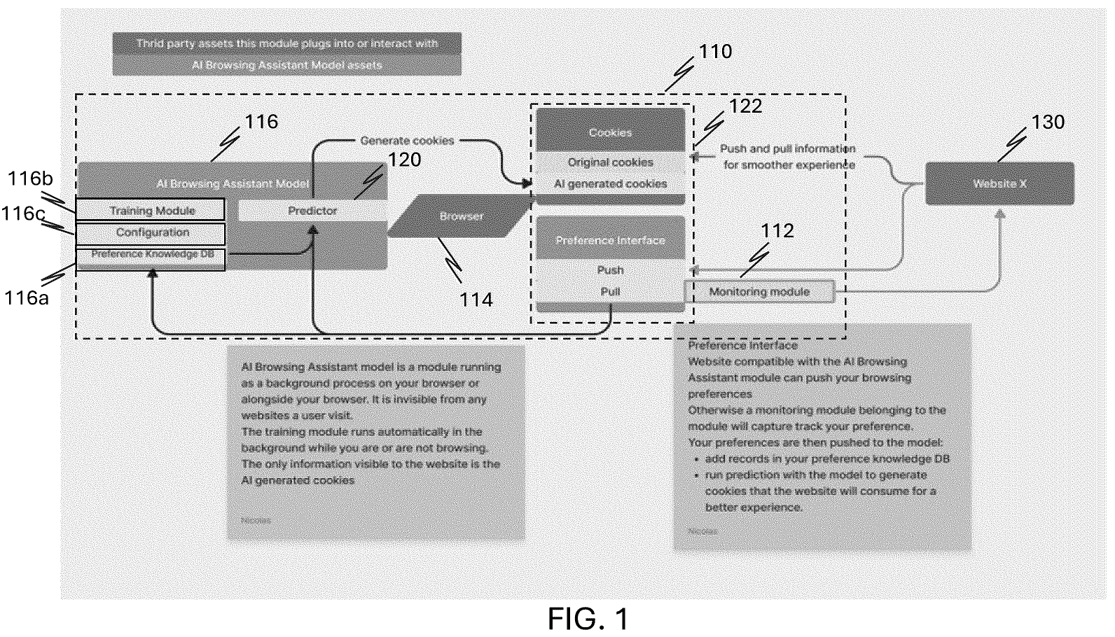

FIG. 1 illustrates the architecture of a computing system in accordance with an example of the disclosed implementations. As illustrated in FIG. 1, the system includes user device 110 (such as a user computer, smartphone, or other device associated with a user) communicating with website/service 130. User device 110 is equipped with monitoring module 112, and browser 114 (such as a MICROSOFT EDGE™ or GOOGLE CHROME™. Monitoring module 112 can be configured to monitor user interactions with one or more remote computing resources in a known manner. These resources could include, but are not limited to, websites, applications, or other digital platforms/services. Monitoring module can use any conventional techniques for monitoring user activity/interactions. For example, Click Tracking (records which elements on a page users click), Scroll Tracking (monitors how far users scroll down a page), Session Recordings (captures video playback of user interactions on a website), Heatmaps (visually represent user interactions, showing where users click, move, and scroll) Funnel Analysis (tracks the steps users take to complete a specific goal), and/or Feature Tagging (tracking specific interactions) techniques can be used. Additionally, analytical tools such as GOOGLE ANALYTICS™ can be employed by monitoring module 112.

User device 110 also includes AI module 116 which can also include preference database 116a, training module 116b, and configuration module 116c. Preference database 116a may be configured to store user preference information which may be determined based on the user interactions monitored by the monitoring module. The user preference information may include, for example, the user's browsing habits, preferences for certain types of content, privacy settings, or other relevant information. Configuration module 116c can store various configuration data.

AI module 112 also includes prediction module 120 which includes a machine learning/AI model. Prediction module 120 can be trained, by training module 116b, based on the user preference information stored in preference database 116. Training module 116b can use any known algorithms for training. Prediction module 120 may be configured to identify/generate (during an inference operation) data (predicted information/information to be shared) that the user is likely to want to share with specific remote computing resources. This could include, for example, user profile information, browsing history, user generated content, or other types of data. Upon establishing a connection with a specific remote computing resource, transmission module 122 of user device 110 may transmit the predicted information to the specific computing resource. This transmission may be accomplished using one or more interfaces compatible with the specific remote computing resource. For example, the interface of browser 120 can be used to transmit the information via HTTP protocol. Further a predefined API of website/service 130 can be used.

In some implementations, the system may be configured to manage user data sharing across multiple user devices. For example, the system may synchronize and manage data sharing settings across all (or a subset) of a user's devices, ensuring consistent application of the user's data sharing preferences regardless of the device used. This feature may simplify the user's digital life and fortify their data against unauthorized access, creating a unified, secure personal network. Accordingly, the term “user device”, as used herein, can refer to a single device or multiple devices associated with the user.

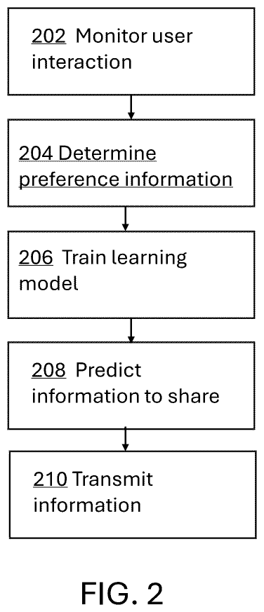

FIG. 2 illustrates a method in accordance with disclosed implementations. At 202, user interactions of the user device with at least one remote computing resource are monitored. At 204, preference information is determined based on the user interactions and stored in a preference database. At 206, a machine learning model is trained based on the user preference information. At 208, in response to establishing a connection of the user device with at least one specific remote computing resource, the learning model predicts information to share with the at least one specific remote computing resource based on the user preference information. At 210, the information is transmitted to the at least one specific computing resource.

The code below is an example of code that can be executed to create an instance of the AI module.
import random
from internal_library import
Vectorizer,RandomForestClassifier,Listener,CookiePublisher,apply_zkclass BaseModel:
   def__init_(self, model):
      “““Dummy class defining basic functions for machine model training”””
      self.model=model
   def async_update_model(self,data):
      “““Function training machine learning as a subprocess given new input data”””
      self.model.fit(data)
   def pull(self):
      “““Function pulling model from other devices to this device to reflect most recent activities on other devices.”””
      self.model.publish( )
   def pull(self):
      “““Function interrupting model training async process”””
      self.model.pause( )
class UserProfile:
   def__init_(self):
      “““Class defining user profile, storing cookie preference, browsing history and demographics”””
      self.browsing_history=[ ]
      self.cookie_preferences={ }
      self.preferences_predictor=UserPreferencePredictor( )
      self.demographics={ }
   def update_browsing_history(self, website_data):
      “““When a new item on a website is consumed, it is added to inform future cookies preference or user preferences.”””
      self.browsing_history.append(website_data)
   def set_cookie_preference(self, cookies_preferences):
      “““Set user cookie preference for a particular domain.”””
      for domain,preference in cookies_preferences.items( ):
         self.cookie_preferences[domain]=preference
   def set_demographics(self,demographics_name,demographics_feature):
      “““Define demographics such as age, sex, revenue bracket”””
      self.demographics.update({demographics_name:demographics_feature})
   def update_preference_predictor(self, website, update_model=False):
      “““Function to generate user preferences for website content based on browsing history.”””
      preference_data={
         “history”:[history[‘content’] for history in self.browsing_history],
         “cookies”: self.cookie_preferences[website[‘domain’]]
      }
      if(update_model):
         #Update model if new information needs to be taken into account by the model
         self.preferences_predictor.update_model(preference_data)
      #Predicting new preferences based on the same historical data (for demonstration)
      new_preferences=self.preferences_predictor.predict_preferences(preference_data)
      return new_preferences
class UserPreferencePredictor(BaseModel):
   def__init_(self):
      ““ ””
      Initialize the machine learning model and vectorizer.
      ““ ””
      self.vectorizer=Vectorizer(stop_words=‘english’) #Class allowing to tokenize text
      self.model=RandomForestClassifier(n_estimators=100, random_state=42) #Example of classifier
   def train_model(self, browsing_histories, preferences):
      ““ ””
      Train the machine learning model using the browsing histories and known preferences.
      Args:
      browsing_histories (list of str): List of text descriptions of browsing content.
      preferences (list of int): List of user preferences corresponding to the browsing histories.
      ““ ””
      X_train=self.vectorizer.fit_transform(browsing_histories)
      self.model.fit(X_train, preferences)
   def update_model(self, model, browsing_histories, preferences):
      X_train=self.vectorizer.fit_transform(browsing_histories)
      self.model=model
      self.model.fit(X_train, preferences)
   def predict_preferences(self, new_browsing_history):
      ““ ””
      Predict user preferences based on new browsing history.
      Args:
      new_browsing_history (list of str): List of text descriptions of browsing content.
      Returns:
      list of int: Predicted preferences.
      ““ ””
      X_new=self.vectorizer.transform(new_browsing_history)
      return self.model.predict(X_new)
class AICookieRecommender(BaseModel):
   def__init_(self, model):
      “““AI model taking user profile, preferences and the current domain to determine which cookies and information to share with the domain”””
      self.model=model
      self.additional_cookies=[ ]
   def predict_new_cookies(self, user_profile, website_policies):
      “““AI defining which data to publish to the domain”””
      features=self.extract_features(user_profile.browsing_history, user_profile.user_preferences)
      predictions=self.model.predict(features)
      recommended_preferences=self.apply_website_policies(predictions, website_policies)
      #Decision-making process
      final_recommendations={ }
      for domain, preference in recommended_preferences.items( ):
         #Consider user's explicit preferences if available
         if domain in user_profile.cookie_preferences:
         final_recommendations[domain]=user_profile.cookie_preferences[domain]
         else:
         final_recommendations[domain]=preference return final_recommendations
   def extract_features(self, browsing_history, user_preferences, website):
      “““Dummy preprocess function to build features prior running the AI model. Data is coming from browsing history, user preferences, demographics and current website.”””
      features={
         “domain_types”: set(history[‘domain_type’] for history in browsing_history),
         “interaction_types”: [history[‘interaction’] for history in browsing_history],
         “content_types”: {preference[‘content_type’]: preference[‘content_score’] for preference in user_preferences}
      }
      context={
         “website_category”: website.category,
         “website_policy”: website.cookies_policy,
         “website_cookies”: website.cookies,
         “requested_demographics”: website.requested_demographics
      }
      return self.model. update_features(features, context) def apply_website_policies(self, predictions, website_policies):
      “““Adjusts predictions according to website's declared cookie policies””” for domain, policy in website_policies.items( ):
         if policy==‘strict’:
         predictions[domain]=False #Override to disallow cookies return predictions
   def add_cookies(self,user_demographics, requested_demographics_list):
      “““Build additional cookies to share in an encrypted manner demographics information from confidential document using ZK-like technoloies”””
      for demographics in requested_demographics_list:
self.additional_cookies.update({demographics:apply_zk(user_demographics,demographics)})
   def async_update_model(self, data):
      “““Dummy function to train”””
      self.model.train(data)
class CategorizeBrowsing:
   def extract_textual_features(self,content):
      ““ ””
      Extract textual features using a Large Language Model.
      Placeholder function that simulates feature extraction.
      ““ ””
      #Hypothetical feature extraction by a model (e.g., sentiment, key entities, themes)
      features={
         ‘sentiment’: ‘positive’, #Dummy sentiment analysis
         ‘key_entities’: [‘entity1’, ‘entity2’], #Dummy entity recognition
         ‘themes’: [‘technology’, ‘innovation’]#Dummy thematic analysis
      }
      return features
   def classify_content(self,features):
      ““ ””
      Classify content into predefined categories using a classifier.
      Placeholder function for content classification.
      ““ ””
      #Hypothetical classification based on extracted features
      if ‘technology’ in features[‘themes’]:
         category=‘Technology’
      else:
         category=‘General’
      return category
   def generate(self,item):
      ““ ””
      Function to augment an item (article or video) with new features.
      ““ ””
      #Extract features using an LLM
      llm_features=self.extract_textual_features(item[‘content’])
      #Classify the content based on the features
      category=self.classify_content(llm_features)
      #Augment the item with new features
      item[‘llm_features’]=llm_features
      item[‘category’]=category
      return item
##To remove
class CookieModel(BaseModel):
   def predict(self, features):
      #Dummy prediction logic
      predictions={ }
      for domain_type in features[‘domain_types’]:
         if random.random( )>0.5:
         predictions[domain_type]=True
         else:
         predictions[domain_type]=False
      return predictions
def main( ):
   module_is_running=True
   listener=Listener( ) #Module listening to user activity.
   user_profile=UserProfile( )
   model=CookieModel( )
   user_predictor=UserPreferencePredictor( )
   recommender=AlCookieRecommender(model)
   augment_browsing_features=CategorizeBrowsing( )
   publisher=CookiePublisher( )
   while module_is_running:
      event=listener.get( )
      if event[“module_shutdown”]:
         module_is_running=False
      if event[“browsing_inactive”]& event[“new_historical_data_available”]:
         #Background task enabling the different machine learning models to be trained without
         user_predictor.async_update_model( )
         recommender.async_update_model( )
      if event[“training_is_complete”]:
         #Upload the models to other devices sharing the same profile user_predictor.publish( )
         recommender.publish( )
         if event[“new_model_available”]:
         #Download a new model that was updated on another device
         user_predictor.pull(event[“new_user_predictor”])
         recommender.pull(event[“new_recommender”])
      if event[‘is_training’]& event[“browsing_active”]:
         #Interrupt training if the user is active again
         user_predictor.pause_training( )
         recommender.pause_training( )
      if event[‘request_for_demographics’]:
         #Add cookies related to demographics provided user approval recommender.add_cookies(event[‘requested_demographics_list’])
      if event[‘browsing_new_website’]:
         #When a user goes on a new webiste
         user_preferences=user_predictor.predict(user_profile.get_browsing_history( ))
         cookies=recommender.predict_new_cookies(event[‘website’], user_profile.get_user_preferences(event[‘website’])
      )
      publisher.set(cookies, user_preferences,event[‘browsing_new_website’])
   if event[‘browsing_new_item’]:
user_profile.update_browsing_history(event[‘website’],augment_browsing_features.g enerate(event[‘current_content’]))
   if event[‘user_updates_preferences’]:
      user_profile.set_cookie_preference(event[‘updates_cookies_preference’])
if name==“_main_”:
   main( )

In FIG. 1, monitoring module 112 is shown as being installed directly on the user device. This could provide a number of advantages, such as allowing the monitoring module to operate independently of any online third parties, providing the user with greater control over their personal data. In other implementations, the monitoring module may be implemented as a browser extension, an app, or in any other suitable manner, whether installed on the user device, or another device. The AI agent can comprise a network of agents associated with a user that report to each other in a peer-to-peer manner or in a hierarchical manner. As an analogy, a person's brain captures knowledge from appendages, eyes, etc . . . , all reporting back to the brain.

The monitoring module may be configured to monitor user interactions across multiple remote computing resources. This could allow the monitoring module to build a more comprehensive profile of the user's preferences and behaviors across multiple services (such as websites), enhancing the quality of the data that the user is able to share with specific remote computing resources. For example, the monitoring module may monitor the user's interactions with a variety of different websites and applications, and use this information to predict the user's likely preferences across a wide range of contexts. The user can override what the AI Agent captures and/or releases as information. A UI can be provided to allow the user to “blacklist” the user's activities on certain websites from being used by the AI. For example, assuming the user has been diagnosed with a confidential medical condition, the user might not want interactions with their doctor, and/or searches relating to the condition to be captured and used by the AI. Also, the user can remove any information that has been captured against their wishes.

The monitoring module may be configured to monitor user interactions in real-time. This could allow the system to maintain up-to-date and accurate user preference information, enhancing the quality of the predictions made by the machine learning prediction module. For example, if the user's browsing habits or content preferences change over time, the system may update the user preference information accordingly, ensuring that the information to share with specific remote computing resources remains aligned with the user's current preferences. In other implementations, the monitoring module may monitor user interactions over a longer period of time, providing a more comprehensive view of the user's preferences and behaviors.

The system may determine user preference information based on the user interactions monitored by the monitoring module. This process may involve analyzing the user's interactions with the remote computing resources and identifying patterns or trends that indicate the user's preferences. For example, the system may determine that the user frequently visits certain types of websites, engages with certain types of content, or adjusts their privacy settings in certain ways. This information may be used to infer the user's preferences and to predict the types of data that the user is likely to want to share with specific remote computing resources.

Preference database 116a may be configured to store a variety of different types of user preference information, including but not limited to the user's browsing habits, content preferences, privacy settings, and other relevant information. Preference database 116a may be designed to facilitate efficient storage and retrieval of user preference information, enabling the system to quickly access and utilize this information when predicting information to share with specific remote computing resources. Preferences can be user-centric as well as location specific or based on other factors. For example, preferences can change based on time of day or season, according to location and/or which other users (other AI modules) are nearby.

In FIG. 1, preference database 116a is shown as located on the user device. This could provide a number of advantages, such as allowing the user to maintain control over their personal data and ensuring that the user preference information is readily accessible to the system. In other implementations, the preference database may be located on a remote server or in the cloud, providing additional storage capacity and enabling the user preference information to be accessed from multiple devices.

As noted above, the system can use the user preference information to train prediction module. This could involve training module 116b feeding the user preference information into prediction module 120 as training data, thereby enabling the module to learn from the user's past interactions and to make more accurate predictions about the types of data that the user is likely to want to share. As noted above, training module 116b and prediction module 120 can use various machine learning techniques to train prediction module 120. For instance, supervised learning models, where the model is trained on a labeled dataset, with the user preference information serving as the labels can be used in this implementation, the model may learn to predict the user's preferences based on patterns in the user's past interactions with remote computing resources. Unsupervised learning models, wherein the model identifies patterns or structures within the user preference information without the need for explicit labels can also be used. For instance, the model may use clustering algorithms to group similar types of user preferences together, or it may use dimensionality reduction techniques to identify the most important features within the user preference information.

Further, prediction module 120 may employ reinforcement learning models. such a model learns to make predictions by interacting with the environment and receiving feedback in the form of rewards or penalties. For example, the module may receive a reward when it accurately predicts the user's preferences, and a penalty when it makes an inaccurate prediction. Over time, the model may learn to make more accurate predictions in order to maximize its cumulative reward. For example, an AI module might capture data from a remote computing resource, put that through a prediction module to recommend, decide and act or capture the subsequent behavior and make a comparison so it can re-learn.

In some implementations, prediction module 120 may use a combination of different machine learning models. For example, the module may use a supervised learning model to make initial predictions based on the user preference information, and then refine these predictions using an unsupervised learning model or a reinforcement learning model. This multi-model approach may allow the module to leverage the strengths of different machine learning techniques, enhancing the accuracy and robustness of its predictions. The prediction model can also be a pretrained model that is fine-tuned based on the preference data or leverages transfer learning.

In some implementations, prediction module 120 may be trained offline using the user preference information collected during the user's browsing sessions. This offline training process may allow the model to learn from a large amount of data without impacting the user's browsing experience. Once the model has been trained, it may be updated periodically with new user preference information to ensure that its predictions remain accurate and up-to-date.

In other implementations, prediction module 120 may be trained online, with the model learning and updating its predictions in real-time as the user interacts with remote computing resources. This online training process may allow the model to adapt quickly to changes in the user's preferences, providing a more responsive and personalized user experience.

Further, prediction module 120 may be trained using a combination of offline and online training processes. For instance, the model may be initially trained offline using a large dataset of user preference information, and then fine-tuned online based on the user's real-time interactions. This hybrid training approach may provide a balance between the robustness of offline training and the responsiveness of online training, enhancing the overall performance of t prediction module 120.

AI module 116 can operate as a browser extension that can be personalized by the user. This browser extension may be installed on the user's web browser and may interact with, for example, the web pages that the user visits, monitoring the user's interactions with these pages and determining user preference information based on these interactions. The browser extension may be designed to operate seamlessly with the user's web browser, providing a user-friendly interface that allows the user to easily manage their data sharing preferences. The browser extension may allow for the creation of multiple user profiles that can be switched seamlessly. Each user profile may represent a different set of user preferences, allowing the user to easily switch between different data sharing settings depending on their current needs or preferences. For example, the user may have one profile for browsing news websites, where they are willing to share more information in exchange for personalized news recommendations, and another profile for browsing shopping websites, where they prefer to keep their information more private.

In some implementations, the browser extension may interact with other browser agents, such as browser plugins or scripts, to monitor user interactions and determine user preference information. These browser/AI agents may provide additional functionality to the web browser, such as blocking unwanted ads, enhancing website security, or improving website performance. The AI module may work in conjunction with these browser agents to provide a comprehensive solution for managing user data sharing across various digital platforms. For example, the AI module can act as a proxy between the user and internet content.

In some implementations, the AI module may establish a secure connection with the computing resources to ensure the privacy and integrity of the data being shared. This secure connection may be established using encryption protocols, such as Secure Sockets Layer (SSL) or Transport Layer Security (TLS), which encrypt the data being transmitted between the user device and the remote computing resources. This feature may provide an additional layer of security for the user's personal data, protecting it from unauthorized access or interception during transmission.

In some implementations, the prediction process may involve generating a set of potential data items to share, and then ranking these items based on their predicted relevance to the user's preferences. The prediction module may use various machine learning techniques to perform this ranking, such as regression models, ranking algorithms, or other suitable techniques. The highest-ranked data items may then be selected for sharing with the specific remote computing resources.

Prediction module 120 may predict information to share with the specific remote computing resource based on a combination of the user preference information and additional contextual information. To ensure a good browsing experience, the AI module may share this information ahead of time with specific remote computing resource to allow the website/app to create the best content that will be ready when the user wants to consume it. This contextual information could include, for example, the current time, the user's location, the user's recent browsing history, or other relevant contextual factors. By considering both the user preference information and the contextual information, prediction module 120 may be able to make more accurate and contextually relevant predictions.

Prediction module 120 may predict different types of information to share with different types of remote computing resources. For example, the module may predict that the user is likely to want to share browsing history data with a news website, but not with a shopping website. Alternatively, the module may predict that the user is likely to want to share demographic information with a marketing website, but not with a social media website. This feature may allow the prediction module to tailor its predictions to the specific needs and preferences of the user and the specific characteristics of the remote computing resources.

In some implementations, the prediction module may predict information to share with the specific remote computing resource based on the user's past interactions with that resource. For instance, if the user has previously shared certain types of data with a specific website, the prediction module may predict that the user is likely to want to share similar types of data with that website in the future. This feature may allow the prediction module to learn from the user's past behavior and to adapt its predictions accordingly.

The information transmission process may involve sending the predicted information over a computer network, such as the internet, to the specific remote computing resource. The transmission process may be facilitated by transmission module 122, which may be configured to handle the technical implementations of transmitting the information, such as formatting the information for transmission, establishing a connection with the remote computing resource, and managing the transmission of the information. Transmission module 122 may be configured to transmit the predicted information using one or more interfaces compatible with the specific remote computing resource. These interfaces may be designed to facilitate the exchange of information between the user device and the remote computing resource, ensuring that the information is transmitted in a format that the remote computing resource can understand and process. The interfaces may be based on standard internet protocols, such as HTTP or FTP, or they may be based on proprietary protocols developed by the operators of the remote computing resource.

Transmission module 122 may determine the appropriate interface to use based on the characteristics of the specific remote computing resource. For instance, transmission module 122 may analyze the technical specifications of the remote computing resource, such as its operating system, its network capabilities, or its supported protocols, and select an interface that is compatible with these specifications. This feature may allow transmission module 122 to adapt to a wide range of remote computing resources, ensuring that the predicted information can be transmitted effectively regardless of the specific characteristics of the remote computing resource.

Transmission module 122 can transmit the predicted information as soon as it is generated by the prediction module, ensuring that the remote computing resource receives the information in a timely manner. Alternatively, transmission module 122 may buffer the predicted information and transmit it in batches at regular intervals, reducing the network load and improving the efficiency of the transmission process. Transmission module 122 may be configured to handle errors or disruptions in the transmission process. For instance, if the transmission of the predicted information is interrupted due to a network outage or a technical issue with the remote computing resource, transmission module 122 may retry the transmission after a certain period of time, or it may switch to a different interface or protocol to complete the transmission. This feature may ensure that the predicted information is transmitted reliably and accurately, even in the face of network disruptions or technical issues.

The information to share may take various forms, depending on the user's preferences and the specific requirements of the remote computing resources. For instance, the information to share may be in the form of “cookies”. As noted above, cookies are small pieces of data that are stored on the user's device by the websites that the user visits. These cookies may contain various types of information, such as the user's browsing history, login information, or other types of data that the website uses to personalize the user's experience. The AI module may generate these cookies based on the user preference information, ensuring that the cookies contain only the information that the user is willing to share with a particular website or other recipient.

Alternatively, the information to share may comprise smart home information collected from a user's smart home platform. For example, the user may have a smart home system that collects various types of data, such as energy usage data, appliance efficiency data, or lifestyle habit data. This smart home information can be share with specific remote computing resources, provided that the user has given their consent. This feature may allow the user to share valuable smart home data with remote computing resources, potentially enabling new types of personalized services or experiences.

In yet other implementations, the information to share may comprise user profile information. This could include, for example, the user's demographic information, interests, preferences, or other types of profile data. AI module 116 may generate this user profile information based on the user preference information, and share it with specific remote computing resources. This feature may allow the user to receive personalized content or services from these resources, based on their profile information.

The user can be given control over which information is stored in the preference database. For instance, the user may be able to categorize the information, deciding which categories of information they are willing to share and which they prefer to keep private. The user may also be able to create rules that take precedence over the AI's decisions. For example, the user may set a rule that certain types of information should never be shared, regardless of the AI's predictions. This feature may provide the user with greater control over their personal data, allowing them to manage their privacy according to their own preferences.

The negotiation process may also include determining a compensation to be paid to the user in exchange for the information. For example, AI module 122 may negotiate with a remote computing resource to ensure that the user receives a fair price for their data. The price can be in the form of a monetary value, a discount on a purchase, free feature access, or any other expression of value. This price may be determined based on various factors, such as the type and amount of information being shared, the value of the information to the computing resource, and the user's own valuation of their data. AI module 122 may use advanced negotiation algorithms to optimize the compensation received by the user, ensuring that the user is adequately compensated for their data.

The compensation may be provided in the form of cryptocurrency. Cryptocurrencies, such as Bitcoin, Ethereum, or others, may offer a secure and decentralized method of payment that can be easily transferred over the internet. The use of cryptocurrency may provide additional privacy benefits, as the transactions can be conducted anonymously without the need for a central banking authority. In other implementations, the compensation may be provided in the form of product credits. These credits may be redeemable for goods or services offered by the remote computing resources or their partners. For example, a user may receive credits that can be used to purchase items from an online store, to access premium content on a website, or to avail of other benefits.

In yet other implementations, the compensation may be provided in the form of direct bank transfers. AI module 116 may be configured to facilitate these transfers, ensuring that the user receives their compensation in a timely and secure manner. The module may use secure banking protocols to conduct these transfers, protecting the user's financial information from unauthorized access.

The negotiation process noted above may be transparent to the user, with the user being provided with updates on the progress of the negotiations and the terms of data sharing that have been negotiated. This transparency may provide the user with greater control over their data, allowing them to monitor and adjust the negotiations as needed. For example, the user may be able to intervene in the negotiations to adjust the terms of data sharing, or to reject a proposed data sharing agreement if they are not satisfied with the terms. In other disclosed implementations, the negotiation process may be completely automated, with AI module 116 conducting the negotiations on behalf of the user without any user intervention. This automation may provide a seamless and hassle-free experience for the user, allowing them to enjoy personalized content and services from the remote computing resources without having to worry about the complexities of data sharing negotiations.

Further, monitoring module 112 may track how the user's data is being used by the remote computing resources and ensure that payments are made accordingly. This feature may provide transparency and control over the monetization process, allowing the user to monitor how their data is being used and to ensure that they are adequately compensated for their data. For example, information may be shared with permission to further share the information with other parties. Monitoring module 112 may track this sharing and make sure the user is compensated for each further distribution of information.

Also, the system may use known methods for determining an appropriate interface. For example, the system may use a trial-and-error method, where it attempts to transmit the predicted information using different interfaces until it finds one that works. Alternatively, the system may use a predictive method, where it uses machine learning algorithms to predict the most suitable interface based on the characteristics of the remote computing resource and the type of information to be transmitted. These methods may allow the system to select the most effective interface for transmitting the predicted information, enhancing the efficiency and reliability of the transmission process.

In some disclosed implementations, AI module 116 may be scaled for use across multiple devices. This scalability may allow the module to manage user data sharing across a wide range of user devices, such as desktop computers, laptops, smartphones, tablets, or other types of computing devices. The module may be installed on each of these devices, allowing it to monitor user interactions and determine user preference information on each device. This feature may provide a seamless and consistent user experience across all of the user's devices, ensuring that the user's data sharing preferences are consistently applied regardless of the device used.

In some implementations, AI module 116 may be managed at a corporate level to ensure strict compliance with data policies. For instance, a corporation may install the module on all of its employees' devices, and configure the module to enforce the corporation's data sharing policies. This feature may provide a powerful tool for corporations to manage data privacy and compliance across their entire digital infrastructure.

In some implementations, AI module 116 may manage data within apps and Internet of Things (IoT) devices. For example, monitoring module 112 may monitor user interactions within mobile apps, smart home devices, wearable devices, or other types of IoT devices, and determine user preference information based on these interactions. AI module 116 may then share this information with specific remote computing resources, such as app servers or IoT device servers, based on the user's preferences. This feature may allow the module to manage data sharing across a broader ecosystem, extending beyond traditional web browsing to encompass a wide range of digital interactions.

Cryptographic techniques can be used to validate the authenticity of the data without exposing the full information. For example, the transmission module 122 may use zero-knowledge proofs (ZKPs) to prove the validity of private data. ZKPs are a type of cryptographic proof that allow one party to prove to another party that they know a certain piece of information, without revealing the information itself. For example, a ZKP can be generated for each piece of data that is shared with the remote computing resources, providing the remote computing resources with a way to verify the authenticity of the data. This feature may provide an additional layer of security for the user's personal data, ensuring that the data is not only kept private, but also that it is accurately represented to the remote computing resources. Further, other types of cryptographic proofs or techniques to validate the authenticity of the partial private data may be used. These techniques may include, for example, digital signatures, hash functions, or other suitable cryptographic techniques. The specific technique used may depend on various factors, such as the type of data being shared, the security requirements of the remote computing resources, or the computational resources available on the user device.

AI module 116 can build behavioral data that websites could leverage for better user experience. For example, the module may monitor the user's behavior on websites, such as the pages they visit, the links they click on, or the time they spend on each page. The module may analyze this behavioral data and use it to predict the user's likely preferences or interests. This predicted behavioral data may then be shared with the websites that the user visits, allowing the websites to tailor their content or services to the user's predicted preferences. This feature may provide a more personalized and engaging user experience, while still respecting the user's privacy.

The system may be used for parental control, offering a tool for managing online interactions and data sharing. For instance, a parent may install the module on their child's device and configure the module to monitor the child's online activities. The module may generate user preference information based on the child's interactions with remote computing resources, and share this information with the parent. The parent may then use this information to set data sharing preferences for the child, such as blocking certain websites, limiting the amount of data that can be shared, or setting time limits for online activities. This feature may provide parents with a powerful tool for managing their child's online safety and privacy.

In some disclosed implementations, the system may distribute information based on identities and types of computing resources. For example, a user may be an artist and the content of the artist (music, graphics, etc.) can be distributed to computing resources associated with fans of the artist. The AI module may monitor the artist's interactions with their fans on social media platforms, and determine user preference information based on these interactions. The module may then predict information to share with the fans based on this preference information, such as new music releases, upcoming concerts, or other relevant content. This feature may allow the artist to share their content with their fans in a more personalized and engaging way, while still maintaining control over their personal data and other valuable content.

Various types of AI models can be used for prediction. The machine learning prediction module may utilize Artificial Neural Networks (ANNs) decision tree models, random forests or other models, to predict the information to share. Alternatively, linear regression models, such as logistic regression can be used. In some disclosed implementations, the machine learning prediction module may be trained using different loss functions. For example, the module may be trained using a mean squared error loss function for regression tasks, or a cross-entropy loss function for classification tasks. The choice of loss function may depend on the specific task at hand and the nature of the user preference information.

In some implementations, the prediction module may be tuned using various AI tuning algorithms. For instance, the module may be tuned using grid search, where the model's hyperparameters are systematically varied over a predefined grid of values. Alternatively, the module may be tuned using random search, where the hyperparameters are randomly sampled from a predefined distribution. In other implementations, the module may be tuned using Bayesian optimization, where a probabilistic model is used to guide the search for optimal hyperparameters. These tuning algorithms may help to optimize the performance of the machine learning prediction module, ensuring that it provides accurate and reliable predictions.

The implementations described herein can be accomplished by computing devices communicating over a network and can be recorded as instructions on non-transitory computer-readable media. For example, the methods and systems for sharing user information with computing resources over a computer network can be implemented using one or more computing devices, such as desktop computers, laptops, smartphones, tablets, servers, or other suitable computing devices. These computing devices may communicate with each other and with remote computing resources over a network, such as the Internet, a local area network (LAN), a wide area network (WAN), or any other suitable network.

The various modules and components described, such as the monitoring module, preference database, machine learning prediction module, and transmission module, can be implemented as software modules running on one or more processors of the computing devices. These software modules can be written in any suitable programming language, such as C++, Java, Python, or JavaScript, and can be stored as instructions on non-transitory computer-readable media.

Non-transitory computer-readable media suitable for storing these instructions include, but are not limited to, hard drives, solid-state drives, optical discs, flash memory devices, and other types of persistent storage devices. When executed by one or more processors of a computing device, these instructions cause the computing device to perform the various operations and methods described herein. Alternatively, the implementations described can be accomplished using hardware components, such as application-specific integrated circuits (ASICs), field-programmable gate arrays (FPGAs), or other suitable hardware devices. In some implementations, a combination of software and hardware components may be used to implement the described methods and systems.

The AI module can interact with other AI modules from other systems to provide the best or most relevant information according to the user preferences back to their respective parent system. The parent system could be a human, or another AI system. The AI module can be aware of the knowledge and comprehension of any topic that the user is browsing through. The AI module can be given a curriculum representing how different knowledge components are connected to each other. The AI module is able to map the user knowledge onto this curriculum. As such the AI module can predict what is the next pieces of content to be presented in seriatim by particular websites to provide the best next step to acquire new knowledge. The AI module can either communicate this information to apps and websites so they provide the content back to the user. Alternatively, the AI module can interrogate AI system from the apps and websites and extract the content to present it directly to the user in different format.

The AI module can communicate to its parent system through a wide range of interfaces. It can be through text, like a chatbot, through audio, through video or by generating an interactive interface such as a mini-game. Consider education website, the AI module capture the content, the assessment that these websites run on the user. It captures the information across all education website the user is using. The AI module can inform the education website about the best learning content to provide to the user to maximize user engagement through a higher knowledge retention and providing the right content at the right moment.

Consider the example of an education website. The AI module can obtain the metadata corresponding to the next piece of content to be presented to the user. It can request from another system, possibly another AI system the metadata, so it generates the content for the user in the right format. The AI module can interrogate apps or websites, on the behalf of the user, to provide a service that the user requires through explicit or implicit requests, leveraging past experiences, user preferences.

The AI module can enable third party to build a personalized experience by providing unique information from the user. Third parties, without tracking any activities of the user, can build a fully personalized experience, without the need for a long interaction history with the user. The AI module is also able to fetch products, services and information on behalf of the user without interacting directly with a website or an app having a human interface. The AI module can take initiatives in interrogating other AI systems to satisfy what its user has requested implicitly or explicitly.

The computing devices used to implement these methods and systems may also include various input/output devices, such as keyboards, mice, touchscreens, displays, and network interfaces, to facilitate user interaction and communication with remote computing resources. The phrase “remote computing resource, as used herein, refers to any resource that a user interacts with, such as a web site, and app, an API, or a service.

A number of implementations have been described. Nevertheless, it will be understood that various modifications may be made without departing from the spirit and scope of the appended claims.

What is claimed is:

1. A method for sharing user information with computing resources over a computer network, comprising:
monitoring, with a monitoring module, user interactions of the user device with at least one remote computing resource;
determining user preference information based on the user interactions and storing the user preference information in a preference database;
training a machine learning prediction module based on the user preference information;
in response to establishing a connection of the user device with at least one specific remote computing resource, predicting, with the machine learning prediction module, information to share with the at least one specific remote computing resource based on the user preference information; and
transmitting the information to share to the at least one specific computing resource.

2. The method of claim 1, wherein the information to share is in the form of cookies.

3. The method of claim 1, wherein the information to share comprises smart home information collected from a user smart home platform.

4. The method of claim 1, wherein the information to share comprises user profile information.

5. The method of claim 1, further comprising conducting negotiations with multiple remote computing resources to select the at least one specific remote computing resource for receipt of the information to share.

6. The method of claim 1, wherein the user owns the information to share, and further comprising the user receiving compensation in response to the transmitting step.

7. The method of claim 6, wherein the transmitting step is accomplished using one or more interfaces compatible with the at least one specific remote computing resource.

8. The method of claim 1 wherein the information to share includes information stored on multiple user devices and third party devices of relevance to the user.

9. The method of claim 1, further comprising:
reporting the user preference information to a user; and
the user modifying or deleting the preference information.

10. The method of claim 1, wherein the monitoring module comprises a network of agents associated with a user that report the preference information to each other.

11. The method of claim 1, further comprising, the user designating certain types of preference information that are not to be gathered by the monitoring module.

12. The method of claim 1, wherein the preference information is based on at least one of a user identity, a location, a time of day, a social context, or a seasonal period.

13. The method of claim 1, further comprising the at least one specific computing resource using the information to share to present a personalized user experience to the user.

14. The method of claim 13, wherein the personalized user experience includes the at least one specific computing resource to predict an order of content items to be presented to the user in seriatim.

15. The method of claim 14, wherein each of the content items are presented from a single specific computing resource that is selected from the at least one specific computing resource.

16. A system for managing user data sharing across computing devices, comprising:
a monitoring module configured to monitor user interactions with at least one remote computing resource;
a preference database configured to store user preference information determined from the user interactions;
a machine learning prediction module trained on the user preference information; and
a transmission module configured to, in response to establishing a connection with at least one specific remote computing resource, predict information to share with the at least one specific remote computing resource based on the user preference information and transmit the predicted information to the at least one specific computing resource.

17. The system of claim 16, wherein the information to share is in the form of cookies.

18. The system of claim 16, wherein the information to share comprises smart home information collected from a user smart home platform.

19. The system of claim 16 wherein the information to share comprises user profile information.

20. The system of claim 16 further comprising a negotiation module configured to conduct negotiations with multiple remote computing resources to select the at least one specific remote computing resource for receipt of the information to share.

21. The system of claim 16 wherein the user owns the information to share, and wherein the system is further configured to facilitate the user receiving compensation in response to transmitting the predicted information.

22. The system of claim 21, wherein the transmission module is configured to transmit the predicted information using one or more interfaces compatible with the at least one specific remote computing resource.

23. The system of claim 16 wherein the information to share includes information stored on multiple user devices and third party devices of relevance to the user.

24. The system of claim 16, further comprising:
reporting the user preference information to a user; and
the user modifying or deleting the preference information.

25. The system of claim 16, wherein the monitoring module comprises a network of agents associated with a user that report the preference information to each other.

26. The system of claim 16, further comprising, the user designating certain types of preference information that are not to be gathered by the monitoring module.

27. The system of claim 16, wherein the preference information is based on at least one of a user identity, a location, a time of day, a social context, or a seasonal period.

28. The system of claim 16, further comprising the at least one specific computing resource using the information to share to present a personalized user experience to the user.

29. The system of claim 28, wherein the personalized user experience includes the at least one specific computing resource to predict an order of content items to be presented to the user in seriatim.

30. The system of claim 29, wherein each of the content items are presented from a single specific computing resource that is selected from the at least one specific computing resource.

31. A non-transitory computer-readable medium storing instructions that, when executed by a processor, cause the processor to perform operations comprising:
monitoring user interactions of a user device with at least one remote computing resource;
determining user preference information based on the user interactions;
storing the user preference information in a preference database;
training a machine learning prediction module based on the user preference information;
in response to establishing a connection with at least one specific remote computing resource, predicting information to share with the at least one specific remote computing resource based on the user preference information; and
transmitting the predicted information to the at least one specific computing resource.

32. The non-transitory computer-readable medium of claim 31, wherein the information to share is in the form of cookies.

33. The non-transitory computer-readable medium of claim 31, wherein the information to share comprises smart home information collected from a user smart home platform.

34. The non-transitory computer-readable medium of claim 31, wherein the operations further comprise conducting negotiations with multiple remote computing resources to select the at least one specific remote computing resource for receipt of the information to share.

35. The non-transitory computer-readable medium of claim 31, wherein the user owns the information to share, and wherein the operations further comprise facilitating the user receiving compensation in response to transmitting the predicted information.

36. The non-transitory computer-readable medium of claim 35, wherein transmitting the predicted information is accomplished using one or more interfaces compatible with the at least one specific remote computing resource.

37. The non-transitory computer-readable medium of claim 31 wherein the information to share includes information stored on multiple user devices and third party devices of relevance to the user.

38. The non-transitory computer-readable medium of claim 31, further comprising:
reporting the user preference information to a user; and
the user modifying or deleting the preference information.

39. The non-transitory computer-readable medium of claim 31, wherein the monitoring module comprises a network of agents associated with a user that report the preference information to each other.

40. The non-transitory computer-readable medium of claim 31, further comprising, the user designating certain types of preference information that are not to be gathered by the monitoring module.

41. The non-transitory computer-readable medium of claim 31, wherein the preference information is based on at least one of a user identity, a location, a time of day,a social context or a seasonal period.

42. The non-transitory computer-readable medium of claim 31, further comprising the at least one specific computing resource using the information to share to present a personalized user experience to the user.

43. The non-transitory computer-readable medium of claim 42, wherein the personalized user experience includes the at least one specific computing resource to predict an order of content items to be presented to the user in seriatim.

44. The non-transitory computer-readable medium of claim 43, wherein each of the content items are presented from a single specific computing resource that is selected from the at least one specific computing resource.
